(19) United States
(12) Patent Application Publication
(10) Pub. No.: US 2026/0243169 A1
(43) Pub. Date: Aug. 20, 2026

(54) TURBINE BLADE AND GAS TURBINE

(71) Applicant: MITSUBISHI HEAVY INDUSTRIES, LTD., Tokyo (JP)

(72) Inventors: Kazuya NISHIMURA, Tokyo (JP); Takashi HIYAMA, Tokyo (JP); Susumu WAKAZONO, Tokyo (JP)

(21) Appl. No.: 19/164,468

(22) PCT Filed: Apr. 2, 2024
(86) PCT No.: PCT/JP2024/013635

§ 371 Date: Sep. 11, 2025

(30) Foreign Application Priority Data
Apr. 6, 2023 (JP) 2023-062061

(51) Int. Cl. F01D 5/14; F23R 3/02

(52) U.S. Cl. CPC F01D 5/141; F23R 3/02; F05D 2220/32; F05D 2250/71

(57) ABSTRACT

A turbine blade includes a shroud portion located farther to the blade tip-end side than an airfoil portion. A trailing edge side end portion of the shroud portion includes a trailing edge side contact surface formed to face the trailing edge side in the chord direction, and a trailing edge side curved surface connected to the leading edge side end portion of the trailing edge side contact surface. When viewed in the blade height direction, the radius of curvature at a first position of the trailing edge side curved surface is defined as a first radius of curvature, and the radius of curvature at a second position is defined as a second radius of curvature. The trailing edge curved surface has a region that is recessed farther toward the leading edge side than an extension line of the trailing edge side contact surface when viewed in the blade height direction.

### TECHNICAL FIELD

The present disclosure relates to a turbine blade and a gas turbine.

The present application claims the benefit of priority based on Japanese Patent Application No. 2023-062061 filed to the Japanese Patent Office on Apr. 6, 2023, the content of which is incorporated herein by reference.

### BACKGROUND ART

In recent years, there has been a tendency that the blade heights of turbine rotor blades have been increasing (blades are lengthened) in accordance with an increase in gas turbine temperature and efficiency. In the case of such a rotor blade, there is a decrease in vibration frequency due to an increase in blade height, and thus unstable vibration such as flutter becomes more likely to occur.

Therefore, a tip shroud (a shroud portion) is provided at a tip of a blade body constituting each turbine rotor blade so that a natural vibration frequency and structural damping are increased and the occurrence of vibration is suppressed. In the case of such a turbine rotor blade, shroud portions adjacent to each other are brought into contact with each other at contact surfaces in order to reduce blade tip leakage and achieve vibration damping (for example, refer to PTL 1).

### CITATION LIST

### Patent Literature

[PTL 1] International Publication No. WO2015/137393

### SUMMARY OF INVENTION

### Technical Problem

However, in the case of the turbine rotor blade described in PTL 1 described above, regarding a contact surface (hereinafter, referred to as a second contact surface) of one of two shroud portions adjacent to each other in a circumferential direction that is brought into contact with a contact surface (hereinafter, referred to as a first contact surface) of the other of the two shroud portions, a region that is brought into contact with the first contact surface and a region that is not brought into contact with the first contact surface are present on the same plane. In this case, since there is a sudden change in stress at the vicinity of a boundary between the region that is brought into contact with the first contact surface and the region that is not brought into contact with the first contact surface, there is a possibility of a decrease in durability in the vicinity of the boundary.

In view of the above-described circumstances, an object of at least one embodiment of the present disclosure is to improve the durability of a shroud portion of a turbine blade.

### Solution to Problem

(1) According to at least one embodiment of the present disclosure, there is provided a turbine blade including
an airfoil portion that extends in a blade height direction and that includes a pressure surface and a suction surface extending between a leading edge and a trailing edge, and
a shroud portion that is positioned closer to a blade tip side than the airfoil portion is,
in which a trailing edge side end portion of the shroud portion includes
   a trailing edge side contact surface that has a normal line extending along a chord direction of the airfoil portion and that is formed to face a trailing edge side in the chord direction, and
   a trailing edge side curved surface that is connected to an end portion of the trailing edge side contact surface on a leading edge side as seen in the blade height direction,
a leading edge side end portion of the shroud portion includes
   a leading edge side contact surface that has a normal line extending along the chord direction and that is formed to face a leading edge side in the chord direction, and
   a leading edge side curved surface that is connected to an end portion of the leading edge side contact surface on a trailing edge side as seen in the blade height direction, and
at least one of a first condition and a second condition is satisfied on an assumption that a radius of curvature of the trailing edge side curved surface at a first position as seen in the blade height direction is a first radius of curvature, the radius of curvature at a second position, which is farther from the trailing edge side contact surface than the first position is, as seen in the blade height direction is a second radius of curvature, a radius of curvature of the leading edge side curved surface at a third position as seen in the blade height direction is a third radius of curvature, the radius of curvature at a fourth position, which is farther from the leading edge side contact surface than the third position is, as seen in the blade height direction is a fourth radius of curvature, the first condition is regarded as satisfied in a case where the trailing edge side curved surface has a region that is recessed to be closer to the leading edge side than an extension line of the trailing edge side contact surface is as seen in the blade height direction and the second radius of curvature is smaller than the first radius of curvature, and the second condition is regarded as satisfied in a case where the leading edge side curved surface has a region that is recessed to be closer to the trailing edge side than an extension line of the leading edge side contact surface is as seen in the blade height direction and the fourth radius of curvature is smaller than the third radius of curvature.

(2) According to at least one embodiment of the present disclosure, there is provided a gas turbine including
the turbine blade having a configuration of (1) described above and
a combustor for generation of a combustion gas that flows through a combustion gas passage provided with the turbine blade.

### Advantageous Effects of Invention

According to at least one embodiment of the present disclosure, it is possible to improve the durability of a shroud portion of a turbine blade.

### BRIEF DESCRIPTION OF DRAWINGS

FIG. 1 is a schematic configuration diagram of a gas turbine to which a turbine blade according to an embodiment is applied.

FIG. 2 is a schematic view showing a turbine blade (a rotor blade) according to some embodiments as seen in a direction from a suction surface to a pressure surface.

FIG. 3 is a view showing the turbine blade shown in FIG. 2 as seen in a blade height direction, and is a view as seen along arrows A-A in FIG. 2.

FIG. 4 is a diagram for description of shroud portions according to some embodiments that are adjacent to each other in a circumferential direction.

FIG. 5 is an enlarged view of part B of FIG. 4 and shows shroud portions according to an embodiment.

FIG. 6 is an enlarged view of the part B of FIG. 4 and shows shroud portions according to another embodiment.

### DESCRIPTION OF EMBODIMENTS

Hereinafter, several embodiments of the present disclosure will be described with reference to the accompanying drawings. Dimensions, materials, shapes, relative arrangements, and the like of components described as embodiments or shown in the drawings are not intended to limit the scope of the present disclosure, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous” indicating that things are in an equal state do not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, the expressions “being provided with”, “comprising”, “including”, or “having” one component are not exclusive expressions excluding the presence of other components.

### Configuration of Gas Turbine

First, a gas turbine to which a turbine blade according to some embodiments is applied will be described.

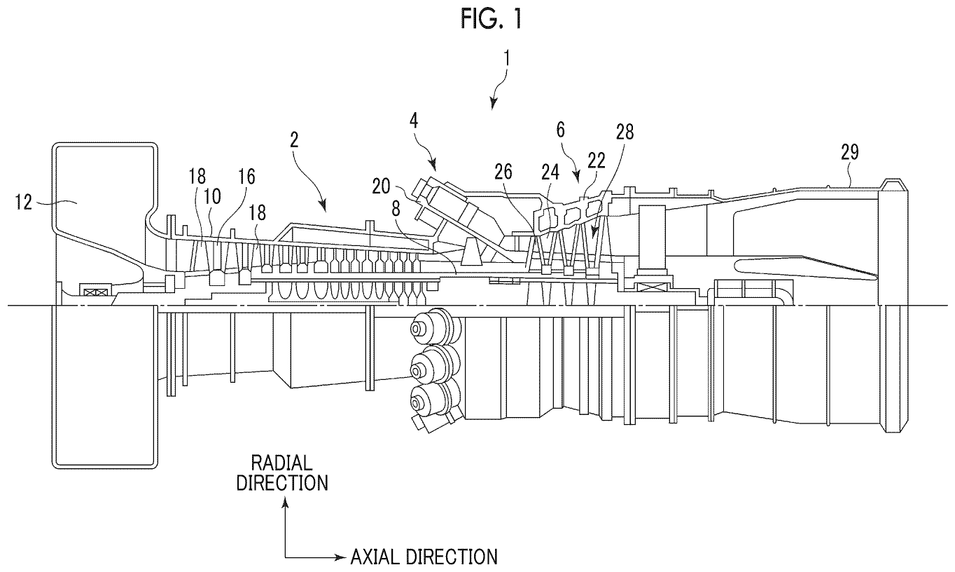

FIG. 1 is a schematic configuration diagram of a gas turbine to which a turbine blade according to an embodiment is applied. As shown in FIG. 1, a gas turbine 1 includes a compressor 2 for generating compressed air, a combustor 4 for generating a combustion gas by using the compressed air and fuel, and a turbine 6 configured to be rotationally driven by the combustion gas. In the case of the gas turbine 1 for power generation, a generator (not shown) is connected to the turbine 6.

The compressor 2 includes a plurality of stator vanes 16 fixed on a compressor casing 10 side, and a plurality of rotor blades 18 embedded in a rotor 8 to be alternately arranged with respect to the stator vanes 16. Air taken in through an air intake port 12 is sent to the compressor 2, and the air passes through the plurality of stator vanes 16 and the plurality of rotor blades 18 and is compressed to become high-temperature and high-pressure compressed air.

The combustor 4 is configured such that the fuel and the compressed air generated by the compressor 2 are supplied thereto, and the fuel and the compressed air are mixed and then burned in the combustor 4 so that the combustion gas, which is a working fluid in the turbine 6, is generated. As shown in FIG. 1, a plurality of the combustors 4 may be disposed in a casing 20 along a circumferential direction around the rotor 8.

The turbine 6 includes a combustion gas passage 28 formed in a turbine casing 22, and a plurality of stator vanes 24 and a plurality of rotor blades 26 provided in the combustion gas passage 28. The stator vanes 24 are fixed on the turbine casing 22 side, and a plurality of stator vanes 24 arranged along the circumferential direction of the rotor 8 constitute a stator vane row. In addition, the rotor blades 26 are embedded in the rotor 8, and a plurality of rotor blades 26 arranged along the circumferential direction of the rotor 8 constitute a rotor blade row. Stator vane rows and rotor blade rows are alternately arranged in an axial direction of the rotor 8.

In the turbine 6, the combustion gas from the combustor 4 that flows into the combustion gas passage 28 passes through the plurality of stator vanes 24 and the plurality of rotor blades 26, so that the rotor 8 is rotationally driven. Accordingly, a generator connected to the rotor 8 is driven to generate power. After driving the turbine 6, the combustion gas is discharged to the outside via an exhaust chamber 29.

In some embodiments, at least one of the rotor blades 26 and the stator vanes 24 of the turbine 6 is a turbine blade 30 to be described below.

### Configuration of Turbine Blade

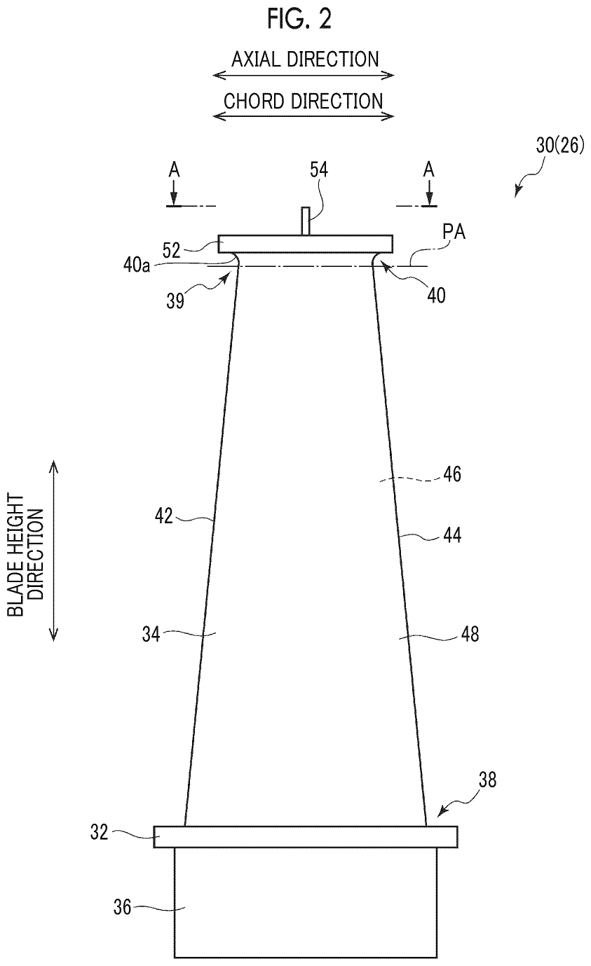

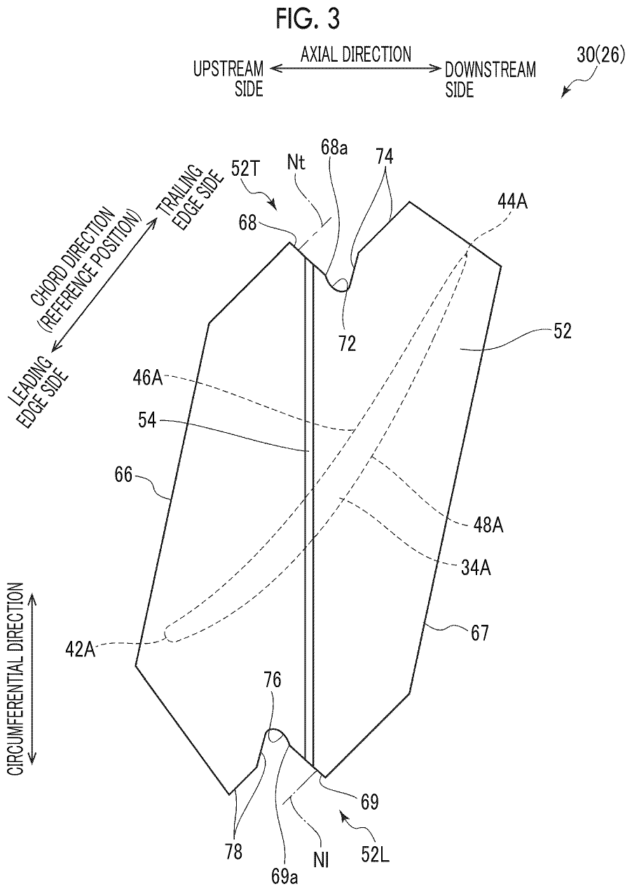

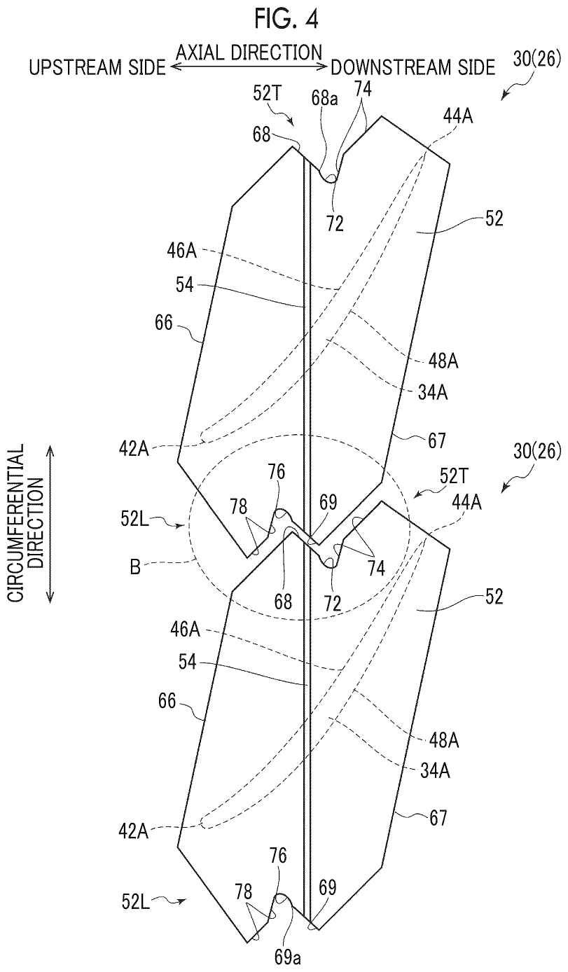

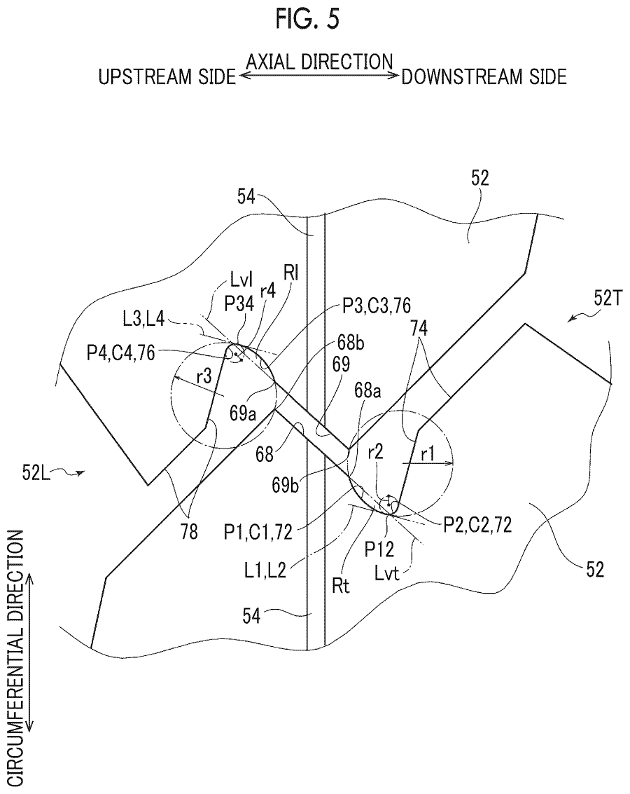

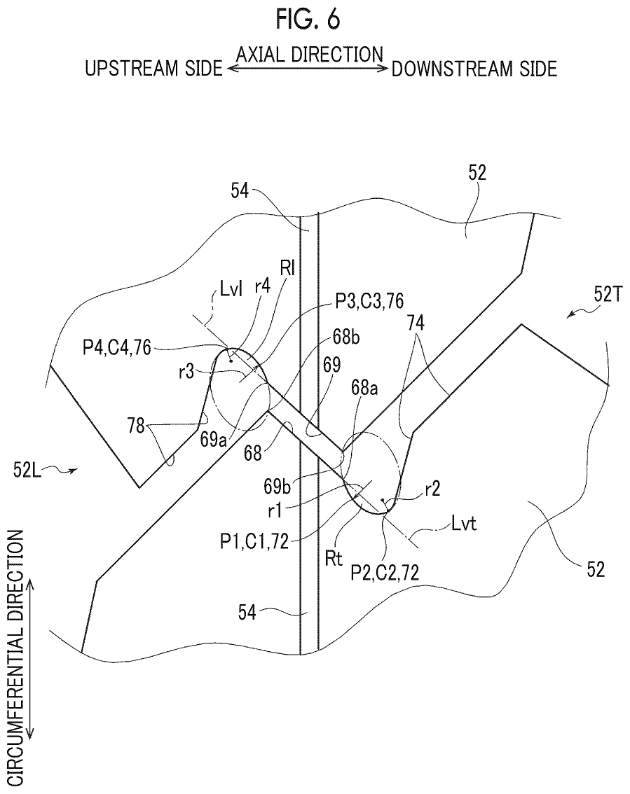

Hereinafter, the turbine blade 30 according to an embodiment will be described in more detail. FIG. 2 is a schematic view showing the turbine blade 30 (the rotor blade 26) according to some embodiments as seen in a direction from a suction surface to a pressure surface (a direction along a rotor circumferential direction). FIG. 3 is a view showing the turbine blade 30 shown in FIG. 2 as seen in a blade height direction, and is a view as seen along arrows A-A in FIG. 2. FIG. 4 is a diagram for description of shroud portions according to some embodiments that are adjacent to each other in the circumferential direction. FIG. 5 is an enlarged view of part B of FIG. 4 and shows shroud portions according to an embodiment. FIG. 6 is an enlarged view of the part B of FIG. 4 and shows shroud portions according to another embodiment.

As shown in FIGS. 2 to 6, the turbine blade 30 (the rotor blade 26) according to some embodiments includes a platform 32, an airfoil portion 34 and a blade root portion 36 that are connected to the platform 32, a shroud portion 52 that is positioned closer to a blade tip side than the airfoil portion 34 is, and a fillet portion 40 that is connected to the shroud portion 52. In addition, the turbine blade 30 includes a fin 54 for reduction of fluid leakage at a blade tip portion of the turbine blade 30.

The airfoil portion 34 extends in the blade height direction (a span direction), includes a base end portion 38 and a tip portion 39 that are both end portions in the blade height direction, and is connected to the platform 32 on the base end portion 38 side. In addition, the airfoil portion 34 includes a leading edge 42 and a trailing edge 44 extending along the blade height direction, and includes a pressure surface 46 and a suction surface 48 extending between the leading edge 42 and the trailing edge 44. The airfoil portion 34 may have a shape that is twisted from the base end portion 38 toward the tip portion 39 in the blade height direction.

The blade root portion 36 is positioned on a side opposite to the airfoil portion 34 with the platform 32 interposed therebetween in the blade height direction. The blade root portion 36 includes an engaging portion having an undulating shape, and the turbine blade 30 is attached to the rotor 8 of the turbine 6 as the engaging portion is engaged with a blade groove provided at a rotor disc (not shown) that rotates together with the rotor 8.

Note that in a state where the turbine blade 30 is attached to the rotor 8, the blade height direction is a direction along a radial direction of the turbine 6. That is, the blade height direction of the turbine blade 30 and the radial direction of the turbine 6 approximately coincide with each other.

As shown in FIG. 2, the fillet portion 40 is formed by a curved surface 40a and is connected to an end portion of the shroud portion 52 on the airfoil portion 34 side. With the fillet portion 40 formed by the curved surface 40a, it is possible to reduce stress concentration at a portion of the shroud portion 52 at which the shroud portion 52 is connected to the airfoil portion 34.

Here, a position in the blade height direction at which the maximum blade thickness of the airfoil portion 34 is smallest will be referred to as a reference position PA, and the airfoil shape of the airfoil portion 34 at the reference position PA will be referred to as a reference airfoil shape 34A. That is, the airfoil portion 34 has a reference airfoil shape 34A of which the maximum blade thickness is smallest at the reference position PA in the blade height direction. The reference position PA approximately coincides with a position at which the fillet portion starts to extend in a direction from the base end portion 38 side to the tip portion 39 side in the blade height direction.

Note that in FIGS. 3 and 4, the above-described reference airfoil shapes 34A projected onto a plane orthogonal to the blade height direction in the blade height direction are shown with broken lines. Each reference airfoil shape 34A has a leading edge 42A, a trailing edge 44A, a pressure surface 46A, and a suction surface 48A. A direction connecting the leading edge 42A and the trailing edge 44A of the reference airfoil shape 34A to each other is a chord direction of the reference airfoil shape 34A. In the following description, the leading edge 42A, the trailing edge 44A, the pressure surface 46A, the suction surface 48A, or the like of the reference airfoil shape 34A may be simply referred to as the leading edge 42A, the trailing edge 44A, the pressure surface 46A, the suction surface 48A, or the like.

In the case of the turbine blade 30 according to some embodiments, the shroud portion 52 is fixed to the tip portion 39 of the airfoil portion 34 via the fillet portion 40. As shown in FIG. 3, the shroud portion 52 includes an upstream side end surface 66 positioned on an upstream side regarding a fluid (the combustion gas) flowing through the combustion gas passage 28 (refer to FIG. 1) of the turbine 6, and a downstream side end surface 67 positioned on a downstream side.

In the case of the turbine blade 30 according to some embodiments, the shroud portion 52 includes a trailing edge side end portion 52T and a leading edge side end portion 52L of the shroud portion 52.

Note that in the following description, the circumferential direction of the rotor 8 may be simply referred to as a circumferential direction, and the axial direction of the rotor 8 may be simply referred to as an axial direction.

In addition, an upstream side regarding a fluid (the combustion gas) that flows through the combustion gas passage 28 (refer to FIG. 1) of the turbine 6 along the axial direction may be referred to as an axial upstream side and a downstream side may be referred to as an axial downstream side (for example, refer to FIG. 3).

The trailing edge side end portion 52T includes a trailing edge side contact surface 68 (a contact surface) that has a normal line Nt extending along the chord direction and that is formed to face the trailing edge 44 side in the chord direction, a trailing edge side curved surface 72 that is connected to, as seen in the blade height direction, an end portion 68a of the trailing edge side contact surface 68 on the leading edge 42 side, and a trailing edge side end surface 74 that is connected to the trailing edge side curved surface 72 and that faces the axial upstream side. Note that the trailing edge side end surface 74 may include a plurality of surfaces extending in different directions as seen in the blade height direction as shown in FIGS. 3 to 6.

The leading edge side end portion 52L includes a leading edge side contact surface 69 (a contact surface) that has a normal line NI extending along the chord direction and that is formed to face the leading edge 42 side in the chord direction, a leading edge side curved surface 76 that is connected to, as seen in the blade height direction, an end portion 69a of the leading edge side contact surface 69 on the trailing edge 44 side, and a leading edge side end surface 78 that is connected to the leading edge side curved surface 76 and that faces the axial downstream side. Note that the leading edge side end surface 78 may include a plurality of surfaces extending in different directions as seen in the blade height direction as shown in FIGS. 3 to 6.

A contact surface (the trailing edge side contact surface 68 and the leading edge side contact surface 69) of the shroud portion 52 is provided to face the shroud portion 52 of the turbine blade 30 adjacent in the circumferential direction. That is, the trailing edge side contact surface 68 of the shroud portion 52 of a certain turbine blade 30 faces the leading edge side contact surface 69 of the shroud portion 52 of the turbine blade 30 adjacent to the turbine blade 30, and is able to come into contact with the leading edge side contact surface 69. For the sake of convenience of description, in FIG. 4, the shroud portions 52 adjacent to each other in the circumferential direction are shown at an interval in the circumferential direction. In addition, the leading edge side contact surface 69 of the shroud portion 52 of a certain turbine blade 30 faces the trailing edge side contact surface 68 of the shroud portion 52 of the turbine blade 30 adjacent to the turbine blade 30, and is able to come into contact with the trailing edge side contact surface 68. Accordingly, movement of the turbine blades 30 in the circumferential direction and/or the axial direction is restricted.

The fin 54 is provided to protrude from the shroud portion 52 toward the blade tip side and to extend along the circumferential direction. An annular seal portion is formed by the fins 54 of the plurality of turbine blades 30 that are arranged in the circumferential direction.

### Regarding Trailing Edge Side Curved Surface 72 and Leading Edge Side Curved Surface 76

The trailing edge side curved surface 72 and the leading edge side curved surface 76 will be further described.

As shown in FIGS. 5 and 6, the radius of curvature of the trailing edge side curved surface 72 at a first position P1 as seen in the blade height direction will be referred to as a first radius of curvature r1 and the radius of curvature at a second position P2, which is farther from the trailing edge side contact surface 68 (from the end portion 68a of the trailing edge side contact surface 68 on the leading edge 42 side) than the first position P1 is, as seen in the blade height direction will be referred to as a second radius of curvature r2.

In addition, the radius of curvature of the leading edge side curved surface 76 at a third position P3 as seen in the blade height direction will be referred to as a third radius of curvature r3 and the radius of curvature at a fourth position P4, which is farther from the leading edge side contact surface 69 (from the end portion 69a of the leading edge side contact surface 69 on the trailing edge 44 side) than the third position P3 is, as seen in the blade height direction will be referred to as a fourth radius of curvature r4.

As shown in FIGS. 5 and 6, as seen in the blade height direction, the trailing edge side curved surface 72 has a region Rt that is recessed to be closer to the leading edge 42 side than an extension line Lvt of the trailing edge side contact surface 68 is. That is, at least a partial region of the trailing edge side curved surface 72, which includes the position of connection with the end portion 68a of the trailing edge side contact surface 68 on the leading edge 42 side, is positioned closer to the leading edge 42 side than the extension line Lvt is.

Similarly, as seen in the blade height direction, the leading edge side curved surface 76 has a region R1 that is recessed to be closer to the trailing edge 44 side than an extension line Lv1 of the leading edge side contact surface 69 is. That is, at least a partial region of the leading edge side curved surface 76, which includes the position of connection with the end portion 69a of the leading edge side contact surface 69 on the trailing edge 44 side, is positioned closer to the trailing edge 44 side than the extension line Lv1 is.

In the examples shown in FIGS. 5 and 6, the second radius of curvature r2 is smaller than the first radius of curvature r1, and the fourth radius of curvature r4 is smaller than the third radius of curvature r3.

Specifically, in the example shown in FIG. 5, the trailing edge side curved surface 72 includes a first arc C1, of which one end is connected to the end portion 68a of the trailing edge side contact surface 68 on the leading edge 42 side, and a second arc C2, of which one end is connected to the other end of the first arc C1 and of which the other end is connected to an end portion of the trailing edge side end surface 74, the first arc C1 having the first radius of curvature r1, and the second arc C2 having the second radius of curvature r2.

In the example shown in FIG. 5, the leading edge side curved surface 76 includes a third arc C3, of which one end is connected to the end portion 69a of the leading edge side contact surface 69 on the trailing edge 44 side, and a fourth arc C4, of which one end is connected to the other end of the third arc C3 and of which the other end is connected to an end portion of the leading edge side end surface 78, the third arc C3 having the third radius of curvature r3, and the fourth arc C4 having the fourth radius of curvature r4.

In addition, in the example shown in FIG. 6, the trailing edge side curved surface 72 includes a portion of an oval of which one end is connected to the end portion 68a of the trailing edge side contact surface 68 on the leading edge 42 side, and within a prescribed area including the end portion 68a of the trailing edge side contact surface 68 on the leading edge 42 side, the radius of curvature of the trailing edge side curved surface 72 gradually decreases as a distance to the end portion 68a of the trailing edge side contact surface 68 on the leading edge 42 side increases.

In the example shown in FIG. 6, the leading edge side curved surface 76 includes a portion of an oval of which one end is connected to the end portion 69a of the leading edge side contact surface 69 on the trailing edge 44 side, and within a prescribed area including the end portion 69a of the leading edge side contact surface 69 on the trailing edge 44 side, the radius of curvature of the leading edge side curved surface 76 gradually decreases as a distance to the end portion 69a of the leading edge side contact surface 69 on the trailing edge 44 side increases.

### Regarding First Condition and Second Condition

In the case of the turbine blade 30 according to some embodiments, a first condition and a second condition are defined as follows.

In the case of the turbine blade 30 according to some embodiments, the first condition is regarded as satisfied in a case where the trailing edge side curved surface 72 has the region Rt that is recessed to be closer to the leading edge 42 side than the extension line Lvt of the trailing edge side contact surface 68 is as seen in the blade height direction and the second radius of curvature r2 is smaller than the first radius of curvature r1.

In the case of the turbine blade 30 according to some embodiments, the second condition is regarded as satisfied in a case where the leading edge side curved surface 76 has the region R1 that is recessed to be closer to the trailing edge 44 side than the extension line Lv1 of the leading edge side contact surface 69 is as seen in the blade height direction and the fourth radius of curvature is smaller than the third radius of curvature.

In the case of the turbine blade 30 shown in FIGS. 5 and 6, the first condition and the second condition are satisfied.

Note that in the case of the turbine blade 30 according to some embodiments, at least one of the first condition or the second condition may be satisfied.

### Regarding Positional Relationship between End Portion of Trailing Edge Side Contact Surface 68 and End Portion of Leading Edge Side Contact Surface 69

In the examples shown in FIGS. 5 and 6, when the trailing edge side contact surface 68 and the leading edge side contact surface 69 are brought into contact with each other, the end portion 68a of the trailing edge side contact surface 68 on the leading edge 42 side and an end portion 69b of the leading edge side contact surface 69 on the leading edge 42 side are brought into contact with each other.

Similarly, in the examples shown in FIGS. 5 and 6, when the trailing edge side contact surface 68 and the leading edge side contact surface 69 are brought into contact with each other, the end portion 69a of the leading edge side contact surface 69 on the trailing edge 44 side and an end portion 68b of the trailing edge side contact surface 68 on the trailing edge 44 side are brought into contact with each other.

A case where the trailing edge side contact surface 68 extends toward the leading edge 42 side along the extension line Lvt by a distance larger than in the example shown in FIGS. 5 and 6 will be considered. In this case, when the trailing edge side contact surface 68 and the leading edge side contact surface 69 are brought into contact with each other, a pressing force from the leading edge side contact surface 69 acts on a region of the trailing edge side contact surface 68 on the trailing edge 44 side, but no pressing force from the leading edge side contact surface 69 acts on a region of the trailing edge side contact surface 68 on the leading edge 42 side, with the position of contact of the end portion 69b of the leading edge side contact surface 69 on the leading edge 42 side as a boundary. Therefore, at a part of the trailing edge side end portion 52T that is in the vicinity of the position of contact of the end portion 69b of the leading edge side contact surface 69 on the leading edge 42 side, a region in which a sudden change in stress occurs is formed with the position of contact of the end portion 69b of the leading edge side contact surface 69 on the leading edge 42 side as a boundary. Therefore, there may be a decrease in durability of the trailing edge side end portion 52T.

Similarly, a case where the leading edge side contact surface 69 extends toward the trailing edge 44 side along the extension line Lv1 by a distance larger than in the example shown in FIGS. 5 and 6 will be considered. In this case, when the trailing edge side contact surface 68 and the leading edge side contact surface 69 are brought into contact with each other, a pressing force from the trailing edge side contact surface 68 acts on a region of the leading edge side contact surface 69 on the leading edge 42 side, but no pressing force from the trailing edge side contact surface 68 acts on a region of the leading edge side contact surface 69 on the trailing edge 44 side, with the position of contact of the end portion 68b of the trailing edge side contact surface 68 on the trailing edge 44 side as a boundary. Therefore, at a part of the leading edge side end portion 52L that is in the vicinity of the position of contact of the end portion 68b of the trailing edge side contact surface 68 on the trailing edge 44 side, a region in which a sudden change in stress occurs is formed with the position of contact of the end portion 68b of the trailing edge side contact surface 68 on the trailing edge 44 side as a boundary. Therefore, there may be a decrease in durability of the leading edge side end portion 52L.

In the examples shown in FIGS. 5 and 6, as described above, the trailing edge side curved surface 72 has the region Rt that is recessed to be closer to the leading edge 42 side than the extension line Lvt of the trailing edge side contact surface 68 is as seen in the blade height direction. Accordingly, the positions of the end portion 68a of the trailing edge side contact surface 68 on the leading edge 42 side and the end portion 69b of the leading edge side contact surface 69 on the leading edge 42 side at the time of contact between the trailing edge side contact surface 68 and the leading edge side contact surface 69 can be made close to each other, and thus a decrease in durability of the trailing edge side end portion 52T as described above is less likely to occur and the durability of a region in the vicinity of the trailing edge side contact surface 68 can be improved.

In addition, in the example shown in FIGS. 5 and 6, as described above, the leading edge side curved surface 76 has the region R1 that is recessed to be closer to the trailing edge 44 side than the extension line Lv1 of the leading edge side contact surface 69 is as seen in the blade height direction. Accordingly, the positions of the end portion 69a of the leading edge side contact surface 69 on the trailing edge 44 side and the end portion 68b of the trailing edge side contact surface 68 on the trailing edge 44 side at the time of contact between the trailing edge side contact surface 68 and the leading edge side contact surface 69 can be made close to each other, and thus a decrease in durability of the leading edge side end portion 52L as described above is less likely to occur and the durability of a region in the vicinity of the leading edge side contact surface 69 can be improved.

### Regarding Stress Acting on Shroud Portion 52

As a result of the inventors' intensive study, it has been found that a peak of stress generated in the shroud portion 52 by a static force acting due to contact between the trailing edge side contact surface 68 and the leading edge side contact surface 69 occurs in the vicinity of a region of the trailing edge side curved surface 72 or the leading edge side curved surface 76 at which the radius of curvature is smallest. As a result of the inventors' intensive study, it has been found that a peak of stress generated by vibration acting in the vicinity of the trailing edge side contact surface or the leading edge side contact surface occurs at a position relatively close to a position on the trailing edge side curved surface 72 or the leading edge side curved surface 76 at which the trailing edge side contact surface 68 or the leading edge side contact surface 69 comes into contact with a counterpart member.

When the positions of the two peaks are close to each other, there is a decrease in high-cycle fatigue strength of the shroud portion 52. Therefore, it is desirable that the positions of the two peaks are separated from each other.

When the turbine blade 30 satisfies the above-described first condition, a position at which a peak of stress generated by a static force acting on the trailing edge side contact surface 68 occurs can be separated from a position at which a peak of stress generated by vibration acting in the vicinity of the trailing edge side contact surface 68 occurs. In this manner, the high-cycle fatigue strength of the trailing edge side end portion 52T of the shroud portion 52 can be improved.

In addition, when the turbine blade 30 satisfies the above-described second condition, a position where a peak of stress generated by a static force acting on the leading edge side contact surface 69 occurs can be separated from a position where a peak of stress generated by vibration acting in the vicinity of the leading edge side contact surface 69 occurs. In this manner, the high-cycle fatigue strength of the leading edge side end portion 52L of the shroud portion 52 can be improved.

In addition, since the gas turbine 1 according to an embodiment includes the turbine blade 30 according to some embodiments described above, the gas turbine 1 has the same operational effects as the above-described operational effects that are provided by the turbine blade 30 according to some embodiments.

### Regarding Ratio between First Radius of Curvature r1 and Second Radius of Curvature r2

In the case of the turbine blade 30 according to some embodiments, the first radius of curvature r1 may be equal to or larger than 1.5 times the second radius of curvature r2 in a case where the first condition is satisfied.

In this case, a position at which a peak of stress generated by a static force acting on the trailing edge side contact surface 68 occurs can be further separated from a position at which a peak of stress generated by vibration acting in the vicinity of the trailing edge side contact surface 68 occurs.

### Regarding Ratio between Third Radius of Curvature r3 and Fourth Radius of Curvature r4

In the case of the turbine blade 30 according to some embodiments, the third radius of curvature r3 may be equal to or larger than 1.5 times the fourth radius of curvature r4 in a case where the second condition is satisfied.

In this case, a position at which a peak of stress generated by a static force acting on the leading edge side contact surface 69 occurs can be further separated from a position at which a peak of stress generated by vibration acting in the vicinity of the leading edge side contact surface 69 occurs.

As shown in FIG. 5, in the case of the turbine blade 30 according to some embodiments, the trailing edge side curved surface 72 may include, as seen in the blade height direction, the first arc C1 having the first radius of curvature r1 and the second arc C2 having the second radius of curvature r2 in a case where the first condition is satisfied.

In this case, the shape of the trailing edge side curved surface 72 can be relatively simplified, so that the trailing edge side curved surface 72 can be easily formed.

Similarly, in the case of the turbine blade 30 according to some embodiments, the leading edge side curved surface 76 may include, as seen in the blade height direction, the third arc C3 having the third radius of curvature r3 and the fourth arc C4 having the fourth radius of curvature r4 in a case where the second condition is satisfied.

In this case, the shape of the leading edge side curved surface 76 can be relatively simplified, so that the leading edge side curved surface 76 can be easily formed.

As shown in FIG. 5, in the case of the turbine blade 30 according to some embodiments, a tangent L1 of the first arc C1 may coincide with a tangent L2 of the second arc C2 at a position of contact P12 between the first arc C1 and the second arc C2.

In this case, the first arc C1 and the second arc C2 can be smoothly connected to each other, and thus it is possible to suppress occurrence of a peak of stress generated by a static force acting on the trailing edge side contact surface 68 at an undesired position.

Similarly, in the case of the turbine blade 30 according to some embodiments, a tangent L3 of the third arc C3 may coincide with a tangent L4 of the fourth arc C4 at a position of contact P34 between the third arc C3 and the fourth arc C4.

In this case, the third arc C3 and the fourth arc C4 can be smoothly connected to each other, and thus it is possible to suppress occurrence of a peak of stress generated by a static force acting on the leading edge side contact surface 69 at an undesired position.

As shown in FIG. 6, in the case of the turbine blade 30 according to some embodiments, at least a partial region of the trailing edge side curved surface 72 may be formed such that a radius of curvature gradually decreases as a distance to the end portion 68a of the trailing edge side contact surface 68 on the leading edge 42 side increases as seen in the blade height direction, in a case where the first condition is satisfied. For example, in the example shown in FIG. 6, at least a partial region of the trailing edge side curved surface 72 is formed to include a portion of an oval so that the radius of curvature gradually decreases as the distance to the end portion 68a of the trailing edge side contact surface 68 on the leading edge 42 side increases. However, the trailing edge side curved surface 72 may be formed to include a portion of a quadratic curve other than an oval so that the radius of curvature gradually decreases as the distance to the end portion 68a of the trailing edge side contact surface 68 on the leading edge 42 side increases,

In this case, a position at which a peak of stress generated by a static force acting on the trailing edge side contact surface 68 occurs can be separated from a position at which a peak of stress generated by vibration acting in the vicinity of the trailing edge side contact surface 68 occurs.

Similarly, in the case of the turbine blade 30 according to some embodiments, at least a partial region of the leading edge side curved surface 76 may be formed such that a radius of curvature gradually decreases as a distance to the end portion 69a of the leading edge side contact surface 69 on the trailing edge 44 side increases as seen in the blade height direction, in a case where the second condition is satisfied. For example, in the example shown in FIG. 6, at least a partial region of the leading edge side curved surface 76 is formed to include a portion of an oval so that the radius of curvature gradually decreases as the distance to the end portion 69a of the leading edge side contact surface 69 on the trailing edge 44 side increases. However, the leading edge side curved surface 76 may be formed to include a portion of a quadratic curve other than an oval so that the radius of curvature gradually decreases as the distance to the end portion 69a of the leading edge side contact surface 69 on the trailing edge 44 side increases.

In this case, a position at which a peak of stress generated by a static force acting on the leading edge side contact surface 69 occurs can be separated from a position at which a peak of stress generated by vibration acting in the vicinity of the leading edge side contact surface 69 occurs.

The present disclosure is not limited to the above-described embodiments, and includes modifications of the above-described embodiments and a combination of these embodiments as appropriate.

For example, the contents described in each embodiment are understood as follows.

(1) The turbine blade 30 according to at least one embodiment of the present disclosure is the turbine blade 30 including the airfoil portion 34 that extends in the blade height direction and that includes the pressure surface 46 and the suction surface 48 extending between the leading edge 42 and the trailing edge 44, and the shroud portion 52 that is positioned closer to a blade tip side than the airfoil portion 34 is. The trailing edge side end portion 52T of the shroud portion 52 includes the trailing edge side contact surface 68 that has the normal line Nt extending along the chord direction of the airfoil portion 34 and that is formed to face the trailing edge 44 side in the chord direction, and the trailing edge side curved surface 72 that is connected to the end portion 68a of the trailing edge side contact surface 68 on the leading edge 42 side as seen in the blade height direction. The leading edge side end portion 52L of the shroud portion 52 includes the leading edge side contact surface 69 that has the normal line N1 extending along the chord direction and that is formed to face the leading edge 42 side in the chord direction, and the leading edge side curved surface 76 that is connected to the end portion 69a of the leading edge side contact surface 69 on the trailing edge 44 side as seen in the blade height direction. The radius of curvature of the trailing edge side curved surface 72 at the first position P1 as seen in the blade height direction will be referred to as the first radius of curvature r1, and the radius of curvature at the second position P2, which is farther from the trailing edge side contact surface 68 than the first position P1 is, as seen in the blade height direction will be referred to as the second radius of curvature r2, The radius of curvature of the leading edge side curved surface 76 at the third position P3 as seen in the blade height direction will be referred to as the third radius of curvature r3, and the radius of curvature at the fourth position P4, which is farther from the leading edge side contact surface 69 than the third position P3 is, as seen in the blade height direction will be referred to as the fourth radius of curvature r4. The first condition is regarded as satisfied in a case where the trailing edge side curved surface 72 has the region Rt that is recessed to be closer to the leading edge 42 side than the extension line Lvt of the trailing edge side contact surface 68 is as seen in the blade height direction and the second radius of curvature r2 is smaller than the first radius of curvature r1. The second condition is regarded as satisfied in a case where the leading edge side curved surface 76 has the region R1 that is recessed to be closer to the trailing edge 44 side than the extension line Lv1 of the leading edge side contact surface 69 is as seen in the blade height direction and the fourth radius of curvature r4 is smaller than the third radius of curvature r3. In the turbine blade 30 according to at least one embodiment of the present disclosure, at least one of the first condition and the second condition is satisfied.

According to the configuration of (1) described above, in a case where the trailing edge side curved surface 72 has the region Rt that is recessed to be closer to the leading edge 42 side than the extension line Lvt of the trailing edge side contact surface 68 is as seen in the blade height direction, a sudden change in stress is less likely to occur in the vicinity of the trailing edge side contact surface 68. Therefore, the durability of a region in the vicinity of the trailing edge side contact surface 68 can be improved.

In addition, in a case where the leading edge side curved surface 76 has the region RI that is recessed to be closer to the trailing edge 44 side than the extension line Lv1 of the leading edge side contact surface 69 is as seen in the blade height direction, a sudden change in stress is less likely to occur in the vicinity of the leading edge side contact surface 69. Therefore, the durability of a region in the vicinity of the leading edge side contact surface 69 can be improved.

When the turbine blade 30 satisfies the above-described first condition, a position at which a peak of stress generated by a static force acting on the trailing edge side contact surface 68 occurs can be separated from a position at which a peak of stress generated by vibration acting in the vicinity of the trailing edge side contact surface 68 occurs. In this manner, the high-cycle fatigue strength of the trailing edge side end portion 52T of the shroud portion 52 can be improved.

In addition, when the turbine blade 30 satisfies the above-described second condition, a position where a peak of stress generated by a static force acting on the leading edge side contact surface 69 occurs can be separated from a position where a peak of stress generated by vibration acting in the vicinity of the leading edge side contact surface 69 occurs. In this manner, the high-cycle fatigue strength of the leading edge side end portion 52L of the shroud portion 52 can be improved.

(2) In some embodiments, in the configuration of (1) described above, at least the first condition may be satisfied. The first radius of curvature r1 may be equal to or larger than 1.5 times the second radius of curvature r2.

According to the configuration of (2) described above, a position at which a peak of stress generated by a static force acting on the trailing edge side contact surface 68 occurs can be further separated from a position at which a peak of stress generated by vibration acting in the vicinity of the trailing edge side contact surface 68 occurs.

(3) In some embodiments, in the configuration of (1) or (2) described above, at least the first condition may be satisfied. The trailing edge side curved surface 72 may include, as seen in the blade height direction, the first arc C1 having the first radius of curvature r1 and the second arc C2 having the second radius of curvature r2.

According to the configuration of (3) described above, the shape of the trailing edge side curved surface 72 can be relatively simplified, so that the trailing edge side curved surface 72 can be easily formed.

(4) In some embodiments, in the configuration of (3) described above, the tangent L1 of the first arc C1 may coincide with the tangent L2 of the second arc C2 at the position of contact P12 between the first arc C1 and the second arc C2.

According to the configuration of (4) described above, the first arc C1 and the second arc C2 can be smoothly connected to each other, and thus it is possible to suppress occurrence of a peak of stress generated by a static force acting on the trailing edge side contact surface 68 at an undesired position.

(5) In some embodiments, in the configuration of any one of (1) to (4) described above, at least the second condition may be satisfied. The third radius of curvature r3 may be equal to or larger than 1.5 times the fourth radius of curvature r4.

According to the configuration of (5) described above, a position at which a peak of stress generated by a static force acting on the leading edge side contact surface 69 occurs can be further separated from a position at which a peak of stress generated by vibration acting in the vicinity of the leading edge side contact surface 69 occurs.

(6) In some embodiments, in the configuration of any one of (1) to (5) described above, at least the second condition may be satisfied. The leading edge side curved surface 76 may include, as seen in the blade height direction, the third arc C3 having the third radius of curvature r3 and the fourth arc C4 having the fourth radius of curvature r4.

According to the configuration of (6) described above, the shape of the leading edge side curved surface 76 can be relatively simplified, so that the leading edge side curved surface 76 can be easily formed.

(7) In some embodiments, in the configuration of (6) described above, the tangent L3 of the third arc C3 may coincide with the tangent L4 of the fourth arc C4 at the position of contact P34 between the third arc C3 and the fourth arc C4.

According to the configuration of (7) described above, the third arc C3 and the fourth arc C4 can be smoothly connected to each other, and thus it is possible to suppress occurrence of a peak of stress generated by a static force acting on the leading edge side contact surface 69 at an undesired position.

(8) In some embodiments, in the configuration of (1) or (2) described above, at least the first condition may be satisfied. At least a partial region of the trailing edge side curved surface 72 as seen in the blade height direction may be formed such that the radius of curvature gradually decreases as a distance to the end portion 68a of the trailing edge side contact surface 68 on the leading edge 42 side increases.

According to the configuration of (8) described above, a position at which a peak of stress generated by a static force acting on the trailing edge side contact surface 68 occurs can be separated from a position at which a peak of stress generated by vibration acting in the vicinity of the trailing edge side contact surface 68 occurs.

(9) In some embodiments, in the configuration of (8) described above, at least the partial region of the trailing edge side curved surface 72 as seen in the blade height direction may be a portion of an oval.

According to the configuration of (9) described above, the shape of the trailing edge side curved surface 72 can be relatively simplified, so that the trailing edge side curved surface 72 can be easily formed.

(10) In some embodiments, in the configuration of any one of (1) to (5), (8), and (9) described above, at least the second condition may be satisfied. At least a partial region of the leading edge side curved surface 76 as seen in the blade height direction may be formed such that the radius of curvature gradually decreases as a distance to the end portion 69a of the leading edge side contact surface 69 on the trailing edge 44 side increases.

According to the configuration of (10) described above, a position at which a peak of stress generated by a static force acting on the leading edge side contact surface 69 occurs can be separated from a position at which a peak of stress generated by vibration acting in the vicinity of the leading edge side contact surface 69 occurs.

(11) In some embodiments, in the configuration of (10) described above, at least the partial region of the leading edge side curved surface 76 as seen in the blade height direction may be a portion of an oval.

According to the configuration of (11) described above, the shape of the leading edge side curved surface 76 can be relatively simplified, so that the leading edge side curved surface 76 can be easily formed.

(12) The gas turbine 1 according to at least one embodiment of the present disclosure includes the turbine blade 30 having a configuration according to any of (1) to (11) described above, and the combustor 4 for generation of a combustion gas that flows through a combustion gas passage provided with the turbine blade 30.

According to the configuration of (12) above, at least the same operational effects as the operational effects that are provided by the turbine blade 30 having a configuration as in (1) described above can be achieved.

### REFERENCE SIGNS LIST

1: gas turbine
4: combustor
6: turbine
26: rotor blade
30: turbine blade
34: airfoil portion
42: leading edge
44: trailing edge
46: pressure surface
48: suction surface
52: shroud portion
68: trailing edge side contact surface
69: leading edge side contact surface
72: trailing edge side curved surface
76: leading edge side curved surface

1. A turbine blade comprising:
an airfoil portion that extends in a blade height direction and that includes a pressure surface and a suction surface extending between a leading edge and a trailing edge; and
a shroud portion that is positioned closer to a blade tip side than the airfoil portion is,
wherein a trailing edge side end portion of the shroud portion includes
a trailing edge side contact surface that has a normal line extending along a chord direction of the airfoil portion and that is formed to face a trailing edge side in the chord direction, and
a trailing edge side curved surface that is connected to an end portion of the trailing edge side contact surface on a leading edge side as seen in the blade height direction,
a leading edge side end portion of the shroud portion includes
a leading edge side contact surface that has a normal line extending along the chord direction and that is formed to face a leading edge side in the chord direction, and
a leading edge side curved surface that is connected to an end portion of the leading edge side contact surface on a trailing edge side as seen in the blade height direction, and
at least one of a first condition and a second condition is satisfied on an assumption that a radius of curvature of the trailing edge side curved surface at a first position as seen in the blade height direction is a first radius of curvature, the radius of curvature at a second position, which is farther from the trailing edge side contact surface than the first position is, as seen in the blade height direction is a second radius of curvature, a radius of curvature of the leading edge side curved surface at a third position as seen in the blade height direction is a third radius of curvature, the radius of curvature at a fourth position, which is farther from the leading edge side contact surface than the third position is, as seen in the blade height direction is a fourth radius of curvature, the first condition is regarded as satisfied in a case where the trailing edge side curved surface has a region that is recessed to be closer to the leading edge side than an extension line of the trailing edge side contact surface is as seen in the blade height direction and the second radius of curvature is smaller than the first radius of curvature, and the second condition is regarded as satisfied in a case where the leading edge side curved surface has a region that is recessed to be closer to the trailing edge side than an extension line of the leading edge side contact surface is as seen in the blade height direction and the fourth radius of curvature is smaller than the third radius of curvature.

2. The turbine blade according to claim 1,
wherein at least the first condition is satisfied, and
the first radius of curvature is equal to or larger than 1.5 times the second radius of curvature.

3. The turbine blade according to claim 1.
wherein at least the first condition is satisfied, and
the trailing edge side curved surface includes, as seen in the blade height direction, a first arc having the first radius of curvature and a second arc having the second radius of curvature.

4. The turbine blade according to claim 3,
wherein a tangent of the first arc coincides with a tangent of the second arc at a position of contact between the first arc and the second arc.

5. The turbine blade according to claim 1,
wherein at least the second condition is satisfied, and
the third radius of curvature is equal to or larger than 1.5 times the fourth radius of curvature.

6. The turbine blade according to claim 1,
wherein at least the second condition is satisfied, and
the leading edge side curved surface includes, as seen in the blade height direction, a third arc having the third radius of curvature and a fourth arc having the fourth radius of curvature.

7. The turbine blade according to claim 6,
wherein a tangent of the third arc coincides with a tangent of the fourth arc at a position of contact between the third arc and the fourth arc.

8. The turbine blade according to claim 1,
wherein at least the first condition is satisfied, and at least a partial region of the trailing edge side curved surface as seen in the blade height direction is formed such that the radius of curvature gradually decreases as a distance to the end portion of the trailing edge side contact surface on the leading edge side increases.

9. The turbine blade according to claim 8,
wherein at least the partial region of the trailing edge side curved surface as seen in the blade height direction is a portion of an oval.

10. The turbine blade according to claim 1,
wherein at least the second condition is satisfied, and
at least a partial region of the leading edge side curved surface as seen in the blade height direction is formed such that the radius of curvature gradually decreases as a distance to the end portion of the leading edge side contact surface on the trailing edge side increases.

11. The turbine blade according to claim 10,
wherein at least the partial region of the leading edge side curved surface as seen in the blade height direction is a portion of an oval.

12. A gas turbine comprising:
the turbine blade according to claim 1; and
a combustor for generation of a combustion gas that flows through a combustion gas passage provided with the turbine blade.
